(19) United States
(12) Patent Application Publication
(10) Pub. No.: US 2019/0384938 A1
(43) Pub. Date: Dec. 19, 2019

(54) STORAGE APPARATUS AND METHOD FOR ADDRESS SCRAMBLING

(71) Applicant: C-SKY Microsystems Co., Ltd., Hangzhou, Zhejiang (CN)

(72) Inventors: Yucan GU, Hangzhou (CN); Baolin XIA, Hangzhou (CN); Youfei WU, Hangzhou (CN); Haiming GU, Hangzhou (CN)

(21) Appl. No.: 16/479,480

(22) PCT Filed: Dec. 6, 2018
(86) PCT No.: PCT/CN2018/119492

§ 371 Date: Jul. 19, 2019

(30) Foreign Application Priority Data
Dec. 6, 2017 (CN) 201711278280.2

(51) Int. Cl. G06F 21/79; H04L 9/08

(52) U.S. Cl. CPC G06F 21/79; H04L 9/0894; H04L 9/0869

(57) ABSTRACT

A storage apparatus and method for address scrambling. The apparatus includes: a key-generating module (11) configured to generate a random key; a non-volatile key memory (12) configured to store the random key generated by the key-generating module (11); a key-reading module (13) configured to automatically read the random key stored in the non-volatile key memory (12) and store the random key; a memory control module (15) configured to output, to an address scrambling module (14), an unscrambled address in generated sequential control logic for reading or writing an on-chip memory; and the address scrambling module (14) connected to the memory control module (15), the key-reading module (13), and the memory (16), respectively, and configured to perform, according to the random key read by the key-reading module (13), scrambling processing on the unscrambled address outputted by the memory control module (15) to form a scrambled address, and send the scrambled address to the memory (16). The apparatus can implement scrambling processing on a data address without affecting the efficiency of reading or writing a memory, thus ensuring efficient and secure data reading and writing.

### CROSS REFERENCE TO RELATED APPLICATION

This disclosure claims the benefits of priority to Chinese application number 201711278280.2, filed Dec. 6, 2017, which is incorporated herein by reference in its entirety.

### BACKGROUND

With the rapid development of the System on Chip (SoC) technologies, memories are applied in an increasingly wider range. A memory mainly functions to store a program and various types of data, and the memory is capable of rapidly and automatically accessing the program or data in a system running process. The memory is a device having a “memory” function, and stores information by employing a physical device with two stable states. Data stored in the memory without encryption, however, can be stolen easily. As a result, important data, such as a developed system, a program, and an instruction program, cannot be well protected.

One method of data protection encrypts data before storing the data into memory. As a result, a malicious hacker cannot obtain valid data even if the hacker steals the data from the memory, and a developer's work is protected. An encryption/decryption process includes: a data writing process, wherein a plaintext is encrypted into a ciphertext by using an encryption algorithm and written into a non-volatile memory; and a data reading process, wherein the read ciphertext is restored to be the plaintext by using a decryption algorithm. Although the foregoing process can achieve data protection, existing encryption technologies, such as Advanced Encryption Standard (AES), Data Encryption Standard (DES), and other encryption/decryption algorithms significantly reduce the performance of a system chip and the efficiency of reading from or writing to a memory, and cannot be used on a chip with extremely high performance requirements.

### SUMMARY OF THE DISCLOSURE

Embodiments of the present disclosure provide a storage apparatus for address scrambling. The apparatus can include: a key-generating module configured to generate a random key; a non-volatile key memory configured to store the random key; a key-reading module configured to read and store the random key; a memory control module configured to output an unscrambled address in data generated by reading from or writing to a memory; and the address scrambling module communicatively coupled to the memory control module, the key-reading module, and the memory and configured to perform scrambling processing according to the random key.

Embodiments of the present disclosure further provide a storage method for address scrambling. The method can include: generating a random key and writing the random key into a non-volatile key memory for storage; reading the random key stored in the non-volatile key memory and saving the random key; when data is generated while reading from or writing to a memory, outputting an unscrambled address to an address scrambling module; performing a scrambling processing on an unscrambled address for data generated while reading from or writing to the memory to form a scrambled address; and sending the scrambled address to the memory.

### BRIEF DESCRIPTION OF THE DRAWINGS

To illustrate the technical solutions in embodiments of the present disclosure more clearly, the accompanying drawings required for describing the embodiments are introduced briefly in the following. It is apparent that the accompanying drawings in the following description are only some embodiments of the present disclosure. Those of ordinary skill in the art can obtain other drawings according to the accompanying drawings without creative efforts.

FIG. 1 is a schematic diagram of an exemplary storage apparatus for address scrambling according to some embodiments of the present disclosure.

FIG. 2 is a schematic diagram of an exemplary storage apparatus for address scrambling according to some embodiments of the present disclosure.

FIG. 3 is a flowchart of an exemplary storage method for address scrambling according to some embodiments of the present disclosure.

FIG. 4 is a flowchart of an exemplary storage method for address scrambling according to some embodiments of the present disclosure.

### DETAILED DESCRIPTION

To make the objectives, technical solutions, and advantages of the embodiments of the present disclosure clearer, the technical solutions in the embodiments of the present disclosure are described in the following with reference to the accompanying drawings in the embodiments of the present disclosure. Apparently, the described embodiments are merely some, rather than all, of the embodiments of the present disclosure. Based on the embodiments in the present disclosure, all other embodiments obtained by those of ordinary skill in the art without creative efforts fall within the protection scope of the present disclosure.

To overcome the issues with conventional systems, the disclosed embodiments describe a storage apparatus for address scrambling that improves the security and confidentiality of data encryption without jeopardizing memory reading and writing efficiency.

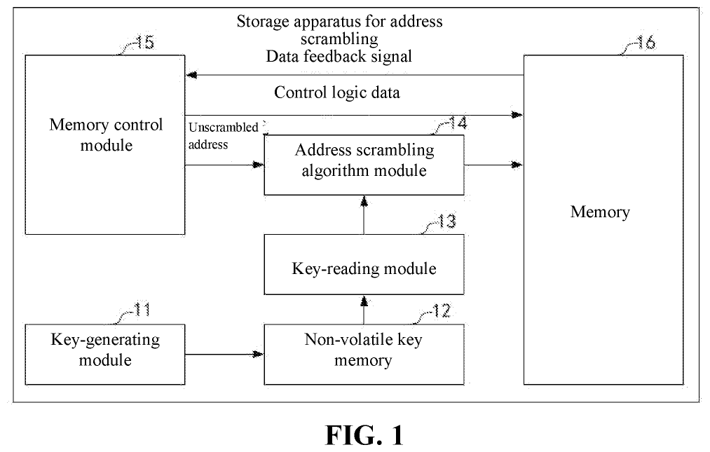

Some embodiments of the present disclosure provide a storage apparatus for address scrambling. FIG. 1 is a schematic diagram of an exemplary storage apparatus for address scrambling, according to some embodiments of the present disclosure. As shown in FIG. 1, the apparatus includes a key generating module 11, a non-volatile memory 12, a key-reading module 13, an address scrambling module 14, a memory control module 15, and a memory 16.

Key-generating module 11 is configured to generate a random key. Non-volatile memory 12 is configured to store the random key generated by the key-generating module 11. Key-reading module 13 is configured to automatically read the random key stored in the non-volatile key memory 12 and store the random key. Memory control module 15 is configured to output, to address scrambling module 14, an unscrambled address in data generated by reading to or writing from memory 16. Address scrambling module 14 is communicatively coupled directly or via one or more components to memory control module 15, key-reading module 13, and memory 16. Address scrambling module 14 is configured to perform, according to the random key read by key-reading module 13, scrambling processing on the unscrambled address outputted by memory control module 15 to form a scrambled address and configured to send the scrambled address to memory 16.

The storage apparatus for address scrambling provided by the embodiments of the present disclosure mainly employs memory control module 15 to perform scrambling processing on a data storage address, so that data stored in memory 16 is out of order. The scrambling processing of the data address does not affect the memory reading or writing efficiency, thus ensuring efficient and secure data reading and writing. Using key generating module 11, the apparatus further ensures the security and confidentiality of encryption by generating a random key corresponding to the apparatus and storing the random key in non-volatile key memory 12, so that the random key read by key-reading module 13 corresponds to the apparatus uniquely. Moreover, the scrambling processing creates a one-to-one correspondence between the scrambled and unscrambled addresses, so that memory control module 15 can read from or write to data in memory 16 conveniently.

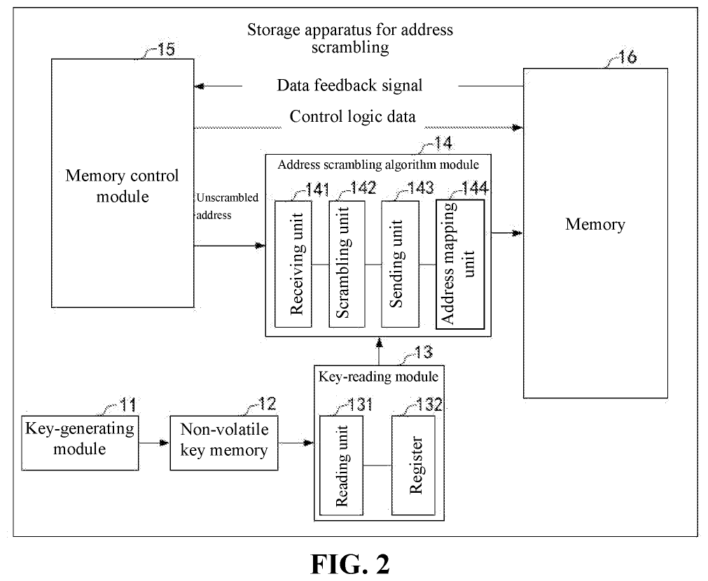

In some embodiments, as shown in FIG. 2, the address scrambling module 14 includes a receiving unit 141, a scrambling unit 142, a sending unit 143, and an address mapping unit 144.

Receiving unit 141 is configured to receive the random key read by key-reading module 13 and the unscrambled address outputted by memory control module 15.

Scrambling unit 142 includes hardware components and is configured to perform, according to the random key read by the key-reading module, periodic scrambling processing on the unscrambled address outputted by the memory control module to form a scrambled address. For example, scrambling unit 142 can employ an XOR hardware component, a sequence-arrangement hardware component, or other hardware components for generating an unordered data address.

Sending unit 143 is configured to send the scrambled address to the memory.

For example, by using the hardware components of scrambling unit 142, the address scrambling module 14 can first perform scrambling processing on the random key and the unscrambled address that are received by receiving unit 141. Meanwhile, the scrambling unit 142 implements scrambling processing on the random key and the unscrambled address in a single cycle. Finally, sending unit 143 sends the scrambled address to the memory for a reading or writing process.

In some embodiments, address scrambling module 14 further includes address mapping unit 144 configured to create a one-to-one correspondence between the unscrambled address in the data generated by reading or writing the memory and the scrambled address. The created correspondence can be according to the following mapping formula, a position specified by the unscrambled address being different from a position specified by the scrambled address:

addr(0, n)<=>addr′(0, n′), n∈(0, x), n′∈(0, x),

wherein unscrambled addresses “addr” are mapped onto scrambled addresses “addr′.” For a specific unscrambled address “addr(0, n)” defined by a vector “n,” there is a specific scrambled address “addr'(0, n′)” defined by another vector “n′” having a one-to-one correspondence with the unscrambled address “addr(0, n).” Both vectors “n” and “n′” belong to the same closed interval “(0, x).” For example, the scrambling of the unscrambled address in can be implemented by using a closed address interval in address scrambling module 14. The unscrambled address can have a one-to-one correspondence to the scrambled address formed after the scrambling, without going beyond the closed address interval. Finally, address mapping unit 144 forms a corresponding mapping relationship, thus improving the memory data reading or writing efficiency of the apparatus.

Key-generating module 11 can be a true random number generator, a pseudo random number generator, a Physically Unclonable Function (PUF), a hardware random generating unit that generates a random key through hardware, or a software random generating unit that generates a random key under the control of software. Key-generating module 11 generates different random keys corresponding to different apparatuses.

For example, key-generating module 11 can generate different keys for different apparatuses, thus ensuring that the key used by each memory 16 is unique. Even if data in memory 16 is identified, it would be impossible to analyze the actual meaning of the stored data. Therefore, the security performance of the apparatus is further improved.

In some embodiments, the random key generated by key-generating module 11 is written once into non-volatile key memory 12 for storage and is unalterable. This applies to scenarios where content in the memory does not need to be updated frequently. In some embodiments, the random key generated by key-generating module 11 is written at least twice into non-volatile key memory 12 for storage. This applies to scenarios where content in the memory will be updated more frequently. After the random key changes, memory 12 can re-initialize data, and all data before the key change becomes invalid, thus further improving the security and efficiency of the apparatus.

In some embodiments, memory control module 15 is connected to memory 16 and is configured to output to memory 16 control logic data in sequential control logic generated for reading or writing an on-chip memory.

In some embodiments, key-reading module 13 include a reading unit 131 and a register 132. Reading unit 131 is configured to automatically read the random key stored in the non-volatile key memory. Register 132 is configured to store the random key.

For example, after the apparatus is powered on, key-reading module 13 can use reading unit 132 to automatically read the random key in non-volatile key memory 12. After acquiring the random key, key reading module 13 stores the random key in register 132, so that the random key can be used by address scrambling module 14. The automatic key reading of the key-reading module can be implemented by hardware circuitry and is not accessible by software.

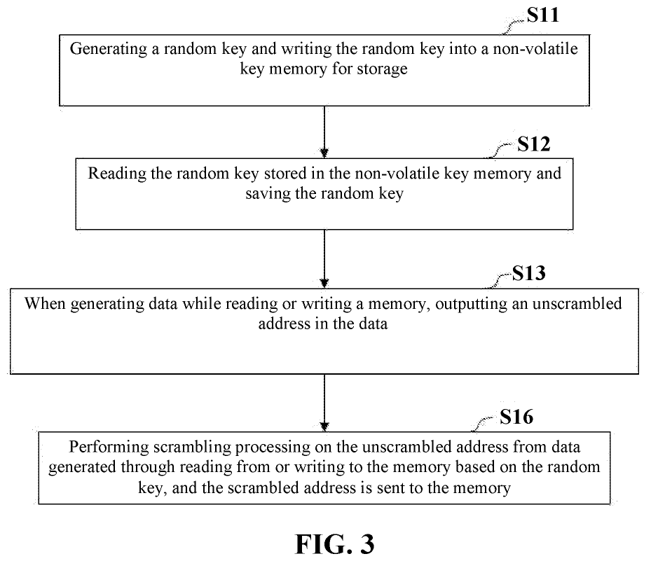

Some embodiments of the present disclosure further provide a storage method for address scrambling. FIG. 3 is a flowchart of a storage method for address scrambling according to some embodiments of the present disclosure. As shown in FIG. 3, the method includes steps S11, S12, S13, and S16.

In step S11, after a storage apparatus is powered on, a key-generating module (e.g., key-generating module 11) generates a random key and writes the random key into a non-volatile key memory (e.g., non-volatile key memory 12) for storage.

In step S12, after an SoC system is reset, a key-reading module (e.g., key-reading module 13) automatically reads the random key stored in the non-volatile key memory and stores the random key.

In step S13, when data is generated while reading from or writing to a memory (e.g., memory 16), an unscrambled address is outputted to an address scrambling module (e.g., address scrambling module 14).

In step S16, scrambling processing is performed on the unscrambled address from data generated through reading from or writing to the memory based on the random key, and the scrambled address is sent to the memory.

For example, in the storage method for address scrambling provided by some embodiments of the present disclosure, after the storage apparatus is powered on, a memory control module (e.g., memory control module 15) performs scrambling processing on a data storage address by using a random key generated by the key-generating module, so that data stored in the memory is out of order. The scrambling processing of the data address does not affect the memory reading or writing efficiency, thus ensuring efficient and secure data reading and writing. In addition, the key-generating module generates a random key that is unique to each apparatus, thus further ensuring the security and confidentiality of encryption of the apparatus. Moreover, a one-to-one correspondence is created between the addresses before and after the scrambling processing, so that the memory control module can read from or write data to the memory conveniently.

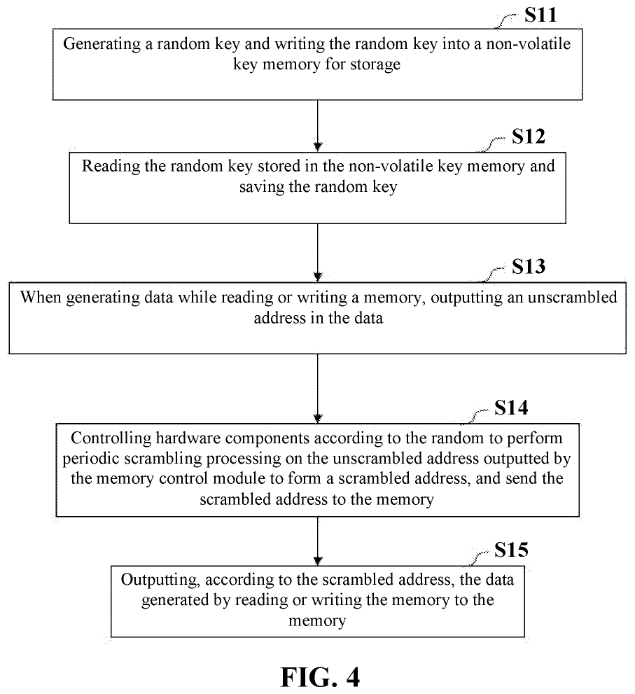

In some embodiments, as shown in FIG. 4, an additional step S14 can be included. In step S14, the step of performing scrambling processing on the unscrambled address according to the random key controls some hardware components. The hardware components perform periodic scrambling processing on the unscrambled address to form a scrambled address. In some embodiments, the scrambled address is sent to the memory.

In some embodiments, as shown in FIG. 4, in step S15, the data generated by reading from or writing to the memory is outputted to the memory using the scrambled address.

The method in these embodiments can be used to control the technical solution of the foregoing apparatus embodiments, and has a similar implementation principle and technical effect. Details are not described here again.

It is appreciated that all or a part of the process involving reading from or writing to the memory in the method in the foregoing embodiments can be implemented by a computer program instructing related hardware. The program can be stored in a computer readable storage medium, and when being executed, the program can include processes of the embodiments of the methods above. The storage medium can be a magnetic disk, an optical disc, a Read-Only Memory (ROM), a Random Access Memory (RAM), etc.

Specific implementation manners of the present disclosure are described above, but the protective scope of the present disclosure is not limited to these implementation manners. Any change or replacement that can be easily conceived of by those skilled in the art without departing from the technical scope disclosed by the present disclosure shall be covered in the protective scope of the present disclosure. Therefore, the protection scope of the present disclosure shall be subject to the protective scope of the claims.

1. A storage apparatus for address scrambling, comprising:
a memory;
a key-generating module configured to generate a random key;
a non-volatile key memory configured to store the random key generated by the key-generating module;
a key-reading module configured to read the random key stored in the non-volatile key memory;
a memory control module configured to output an unscrambled address in data generated by reading from or writing to the memory; and
an address scrambling module communicatively coupled to the memory control module, the key-reading module, and the memory and configured to perform, according to the random key, scrambling processing on the unscrambled address to form a scrambled address, and to send the scrambled address to the memory.

2. The apparatus according to claim 1, wherein the address scrambling module comprises:
a receiving unit configured to receive the random key and the unscrambled address outputted by the memory control module;
a scrambling unit having hardware components and configured to perform, according to the random key, scrambling processing on the unscrambled address to form a scrambled address; and
a sending unit configured to send the scrambled address to the memory.

3. The apparatus according to claim 1, wherein the address scrambling module further comprises:
an address mapping unit configured to create a correspondence between the unscrambled address and the scrambled address.

4. The apparatus according to claim 3, wherein the address mapping unit creates the correspondence according to the following mapping formula, a position specified by the unscrambled address being different from a position specified by the scrambled address:
addr(0, n)<=>addr′(0, n′), n∈(0, x), n′∈(0, x′).

5. The apparatus according to claim 1, wherein the key-generating module is a true random number generator, a pseudo random number generator, a Physically Unclonable Function (PUF), a hardware-based random number generating unit, or a software-based random number generating unit that generates a random key under the control of software.

6. The apparatus according to claim 4, wherein the key-generating module generates different random keys corresponding to different apparatuses.

7. The apparatus according to claim 5, wherein the random key generated by the key-generating module is written into the non-volatile key memory once or more for storage and the random key stored in the non-volatile key memory is unalterable.

8. The apparatus according to claim 1, wherein the memory control module is connected to the memory and is configured to output, to the memory, control logic data in generated sequential control logic for reading or writing an on-chip memory.

9. The apparatus according to claim 8, wherein the key-reading module comprises:
a reading unit configured to read the random key stored in the non-volatile key memory; and
a register configured to store the read random key.

10. A storage method for address scrambling, comprising:
generating a random key and writing the random key into a non-volatile key memory for storage;
reading the random key stored in the non-volatile key memory and saving the random key;
when generating data while reading from or writing to a memory, outputting an unscrambled address;
performing scrambling processing on an unscrambled address for data generated while reading from or writing to the memory to form a scrambled address; and
sending the scrambled address to the memory.

11. The method according to claim 10, wherein generating a random key and writing the random key into a non-volatile key memory for storage is performed when a storage apparatus is powered on for the first time.

12. The method according to claim 10, wherein reading the random key stored in the non-volatile key memory and saving the random key is performed when a system is reset.

13. The method according to claim 10, wherein sending the scrambled address to the memory further comprises:
outputting, according to the scrambled address, the data to the memory.

14. The method according to claim 10, wherein performing scrambling processing further comprises:
controlling hardware components according to the random key to perform periodic scrambling processing on the unscrambled address to form a scrambled address.
